(19) United States
(12) Patent Application Publication
(10) Pub. No.: US 2004/0086269 A1
(43) Pub. Date: May 6, 2004

(54) Method and system for writing video presentation and navigation information direct to optical disc

(75) Inventor: Qiang Huang, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MedioStream, Inc, San Jose, CA

(21) Appl. No.: 10/290,047

(22) Filed: Nov. 6, 2002

(51) Int. Cl. H04N 5/781

(52) U.S. Cl. 386/125; 386/126

(57) ABSTRACT

A method (and system) for directly writing video information to optical disc media, e.g., random. The method includes converting a video information in a first format to a raw video information in an uncompressed format. The method also includes resizing the raw video information in the uncompressed format into a size associated with a desired output media format and a desired TV standard and adjusting the uncompressed format in the size associated with the desired output media format and the desired TV standard to a frame rate associated with the desired TV standard. The method processes the uncompressed format in the size and the frame rate into an elementary video stream and processing the elementary video stream with audio information in the desired output media format and the desired TV standard to form video and audio information in a presentation format including a beginning and an end based upon the desired output media format and the desired TV standard. The video and audio information in the presentation format is continuously transferred from the beginning through a common bus to an output for a disc writer free from an intermediary storage of the video and audio information from the beginning to the end. The method then writes (e.g., burns) the video and audio information in the presentation format from the beginning to a first portion of an optical media while other portions of the video and audio information are being processed to the presentation format.

### CROSS-REFERENCES TO RELATED APPLICATIONS

This present application is related to U.S. Ser. No. 10/202,999 (Attorney Docket No. 019816-002200US) titled “METHOD AND SYSTEM FOR DIRECT RECORDING OF VIDEO INFORMATION ONTO A DISK MEDIUM,” in the name of Qiang Huang, commonly assigned, and hereby incorporated by reference herein.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention is directed to processing video and/or audio information. More particularly, the invention provides a method and system for capturing and converting video information in an incoming format into an outgoing format and then directly writing the video information onto an optical disc medium without an intermediary storage of the entire video information. The invention can be applied to a variety of formats and information including audio information for a variety of applications such as fixed files, streaming video, captured streaming video and/or audio, any combination of these, and the like.

From a long time ago, people have been capturing visual images of moving or animated objects for storage and playback. Images were first captured as still on photographic papers, which were organized in stacks and flipped back to illustrate animation. Although somewhat successful, such images could not imitate a continuous and fluid motion of a moving picture. Later on, images were captured on photosensitive films, which were formed on thin plastic rolls. Such rolls were developed, and then played back using a projector, which included a light source that projected images from such roll through a lens onto a display screen. The projector mechanically scrolled through the roll to output images from the roll of film onto the screen to create a moving picture. The roll of film could be stored and later played back at anytime.

Other ways of distributing moving pictures include television. Television broadcasts moving pictures through one of a plurality of channels, which can be selected. Television has been broadcast through wireless ways, as well as hard cables. Moving pictures can also be broadcast or uni-cast from one location to another through a world wide network of computers, commonly called the Internet. Here, the Internet is a world wide “super-network” which connects together millions of individual computer networks and computers. The Internet is generally not a single entity. It is an extremely diffuse and complex system over where no single entity has complete authority or control. Although the Internet is widely know for one of its ways of presenting information through the World Wide Web (herein “Web”), there are many other services currently available based upon the general Internet protocols and infrastructure.

Video can also be transferred and output through the Internet. A company called RealNetworks, Inc. is a provider of media delivery and digital distribution solutions designed for the Internet. RealNetworks, Inc. has provided a way for video streaming media that enable the delivery and playback of multimedia content using a media player. Unfortunately, such media player is often large in size and difficult to download effectively. It often takes minutes to download such media player over a conventional modem device. Complex instructions also accompany the download and later installation of such media player, which makes the media player difficult to use for most Internet users. Accordingly, streaming media has had some success but still lacks wide spread utilization on the Internet. Other video players have also been used. Such video players include, among others, one manufactured and distributed by Microsoft Corporation of Redmond Wash. Others include Quicktime™ by Apple Computers, Inc. Such video players can often output certain video in a proprietary format. Alternative ways of distributing moving pictures includes the use of video tapes, disks (e.g., DVD, CD-ROM), and the like.

Unfortunately, many different types of sources for video now exist. Such sources include video files, captured video, analog video, streaming video, and others. Many different types of video outputs also exist. Such video output types include DVD, VCD, SuperVCD, and others. Accordingly, compatibility problems have plagued conventional video and video/audio technologies. Additionally, difficulties arise in editing video in a first format to a second format since tools have been limited and often require a great deal of technical skill to use such tools, which are cumbersome.

Specifically, conventional techniques have used more than one application to edit and convert video information. Here, multiple software applications are often needed to perform the editing and conversion process. Such applications are often complex and cannot be easily performed without a high degree of skill. Additionally, many of these applications are incompatible with each other further causing difficulty in the editing and converting process. Conventional techniques also take up a large amount of memory (e.g., disk space) and are extremely time consuming. Many other limitations with regard to conventional techniques can be found throughout the present specification and more particularly below.

From the above, it is seen that an improved technique for processing video information is desired.

### BRIEF SUMMARY OF THE INVENTION

According to the present invention, techniques directed to processing video and/or audio information are provided. More particularly, the invention provides a method and system for capturing and converting video information in an incoming format into an outgoing format and then directly writing the video information onto an optical disc medium without an intermediary storage of the entire video information. The invention can be applied to a variety of formats and information including audio information for a variety of applications such as fixed files, streaming video, captured streaming video and/or audio, any combination of these, and the like.

In a specific embodiment, the invention provides a method for directly writing video information to optical disc media, e.g., random. The method includes converting a video information in a first format to a raw video information in an uncompressed format. The method also includes resizing the raw video information in the uncompressed format into a size associated with a desired output media format and a desired TV standard and adjusting the uncompressed format in the size associated with the desired output media format and the desired TV standard to a frame rate associated with the desired TV standard. The method processes the uncompressed format in the size and the frame rate into an elementary video stream and processing the elementary video stream with audio information in the desired output media format and the desired TV standard to form video and audio information in a presentation format including a beginning and an end based upon the desired output media format and the desired TV standard. The video and audio information in the presentation format is continuously transferred from the beginning through a common bus to an output for a disc writer free from an intermediary storage of the video and audio information from the beginning to the end. The method then writes (e.g., burns) the video and audio information in the presentation format from the beginning to a first portion of an optical media while other portions of the video and audio information are being processed to the presentation format.

In an alternative specific embodiment, the invention provides a computer system for directly writing video information to optical disc media. The system includes one or more memories, which have computer codes or codes. One or more codes is directed to converting a video information in a first format to a raw video information in an uncompressed format. One or more codes is directed to resizing the raw video information in the uncompressed format into a size associated with a desired output media format and a desired TV standard and adjusting the uncompressed format in the size associated with the desired output media format and the desired TV standard to a frame rate associated with the desired TV standard. Additionally, one or more codes is directed to processing the uncompressed format in the size and the frame rate into an elementary video stream and processing the elementary video stream with audio information in the desired output media format and the desired TV standard to form video and audio information in a presentation format including a beginning and an end based upon the desired output media format and the desired TV standard. One or more codes is directed to initiate continuously transferring the video and audio information in the presentation format from the beginning through a common bus to an output for a disc writer free from an intermediary storage of the video and audio information from the beginning to the end. One or more codes is directed to initiate writing the video and audio information in the presentation format from the beginning to a first portion of an optical media while other portions of the video and audio information are being processed to the presentation format. Depending upon the embodiment, there can be other computer codes that carry out the functionality described herein as well as outside of this specification.

Many benefits are achieved by way of the present invention over conventional techniques. For example, the present technique provides an easy to use process that relies upon conventional technology. The invention provides an integrated software application, which can be installed on a conventional personal computer or the like. In other embodiments, the invention allows a user to take any video information in any format and convert such video information into an outgoing format for writing onto a disk media, e.g., CD, DVD. Additionally, the invention is easy to use and efficiently processes video and/or audio information in a faster and more efficient way as compared to conventional video/audio editing and conversion applications. In certain embodiments, the invention uses a lot less hard drive spaces since each of the files (e.g., video recordings, navigation, and file system) is written onto the optical disc in a sequential manner without storing all of such files onto a hard disk medium before transfer and writing to the optical disc. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a conventional video editing and conversion method;

FIG. 2 is a simplified diagram of a digital video processing method according to an embodiment of the present invention;

FIGS. 3A through 3C are more detailed diagrams of video input processes according to embodiments of the present invention;

FIG. 4 is a more detailed diagram of a resizing and adjustment process according to an embodiment of the present invention;

FIG. 5 is a more detailed diagram of a audio adjustment process according to an embodiment of the present invention;

FIG. 6 is a more detailed diagram of a conversion process according to an embodiment of the present invention;

FIG. 7 is a simplified diagram of a video processing method including an editing process according to an embodiment of the present invention;

FIG. 8 is a simplified diagram of system hardware according to an embodiment of the present invention;

FIG. 9 is a simplified diagram of an overall direct writing method according to an embodiment of the present invention;

FIG. 10 is a simplified diagram of an encoding process according to an embodiment of the present invention;

FIG. 11 is a more detailed diagram of an encoding process according to an embodiment of the present invention;

FIG. 12 is a simplified diagram of a process of writing video navigation information according to an embodiment of the present invention; and

FIG. 13 is a simplified diagram of a process of writing video file information according to an embodiment of the present invention.

### DETAILED DESCRIPTION OF THE INVENTION

According to the present invention, techniques directed to processing video and/or audio information are provided. More particularly, the invention provides a method and system for capturing and converting video information in an incoming format into an outgoing format and then directly writing the video information onto an optical disc medium without an intermediary storage of the entire video information. The invention can be applied to a variety of formats and information including audio information for a variety of applications such as fixed files, streaming video, captured streaming video and/or audio, any combination of these, and the like.

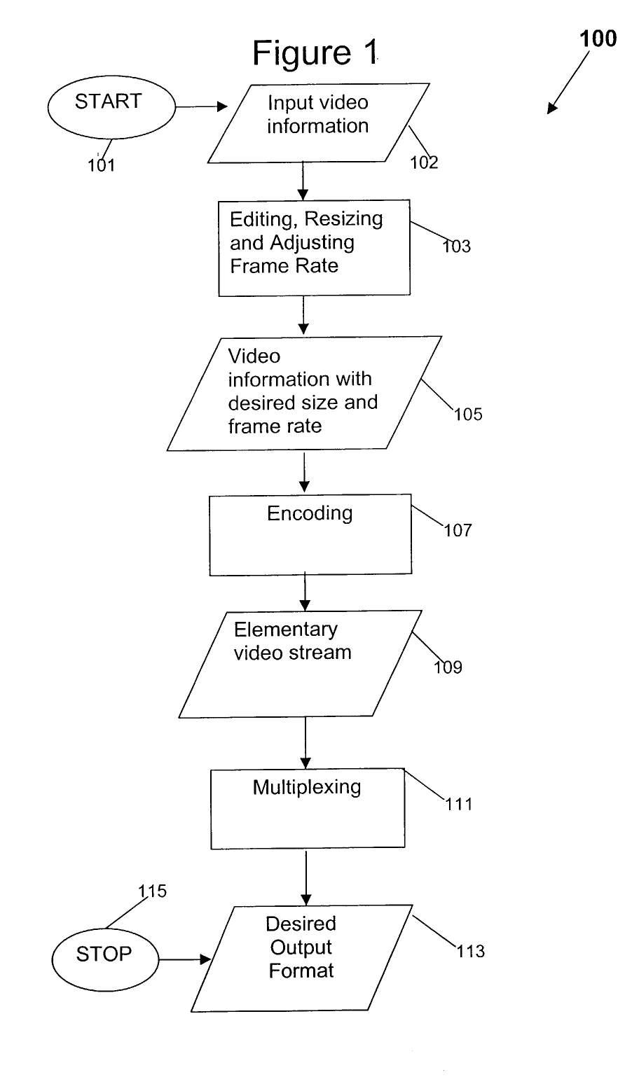

FIG. 1 is a simplified diagram of a conventional method 100 of video editing and conversion. This diagram is merely an example, which should not unduly limit the scope of the claims herein. One of ordinary skill in the art would recognize many other limitations, variations, and modifications. As shown, the method begins with start, step 101, which carries out more than one process often requiring the use of intermediary files, which are often stored in memory. Video information is input, step 102. Here, the video information can be a multi-media file, such as AVI. The method edits, resizes, and adjusts (step 103) the frame rate of the video information. Here, conventional tools such as non-linear video editing software and others are used. The method outputs an intermediary file including the video information with desired size and frame rate 105. The intermediary file is often stored in memory, which takes spaces and is less efficient.

Next, the convention method performs an encoding process, step 107. The encoding process often includes use of conventional tools such as software or hardware encoder and others. The encoding process converts the file with desired size and frame rate to a selected output format, such as MPEG or others. After encoding, the method outputs an elementary video stream 109, which is also in an intermediary file. Such file is often stored.

The conventional method then adds audio information to the elementary video stream in a multiplexing process, step 111. The audio information is in a format such as PCM, MPEG-1, or Dolby Digital formats. Often times, the method uses conventional tools such as disc authoring software to perform the multiplexing process. The conventional method outputs a video/audio file 113 having a desired format. Such file is often stored. The method ends at stop, step 115. As show, the conventional method has many limitations. Depending upon the particular embodiment of the present invention, one or more of these limitations has been overcome by way of the present method and system described throughout the present specification and more particularly below.

A method according to an embodiment of the present invention is provided as follows:

1. Initiate conversion process;

2. Input video information;

3. Convert input video into uncompressed raw video;

4. Transfer uncompressed raw video without any intermediary files;

5. Process raw video to desired output format and TV standard;

6. Process audio information to desired output format;

7. Transfer video and audio in desired formats with any intermediary files;

8. Form desired audio/video output; and

9. Perform other steps, as desired.

As shown, the method performs a sequence of steps to convert video information into a desired format without any intermediary files of conventional techniques. Preferably, the video information can be in almost any format or any format. The output video information can also be in any desired format, depending upon the embodiment. These and other features of the present method can be found throughout the specification and more particularly according to the figures below.

A method according to an alternative embodiment of the present invention is provided as follows:

1. Initiate conversion process;

2. Input video information;

3. Input desired output format from a plurality of formats and input TV standard;

4. Convert input video into uncompressed raw video;

5. Transfer uncompressed raw video without any intermediary files;

6. Process raw video to desired output format and TV standard based upon response from input of desired output format and input of TV standard;

7. Process audio information to desired output format;

8. Transfer video and audio in desired formats with any intermediary files;

9. Form desired audio/video output; and

10. Perform other steps, as desired.

As shown, the method performs a sequence of steps to convert video information into a desired format without any intermediary files of conventional techniques. Preferably, the video information can be in almost any format or any format. The output video information can also be in any desired format, depending upon the embodiment. More preferably, the user selects the desired output format and TV standard using a user interface, e.g., graphical user interface. These and other features of the present method can be found throughout the specification and more particularly according to the figures below.

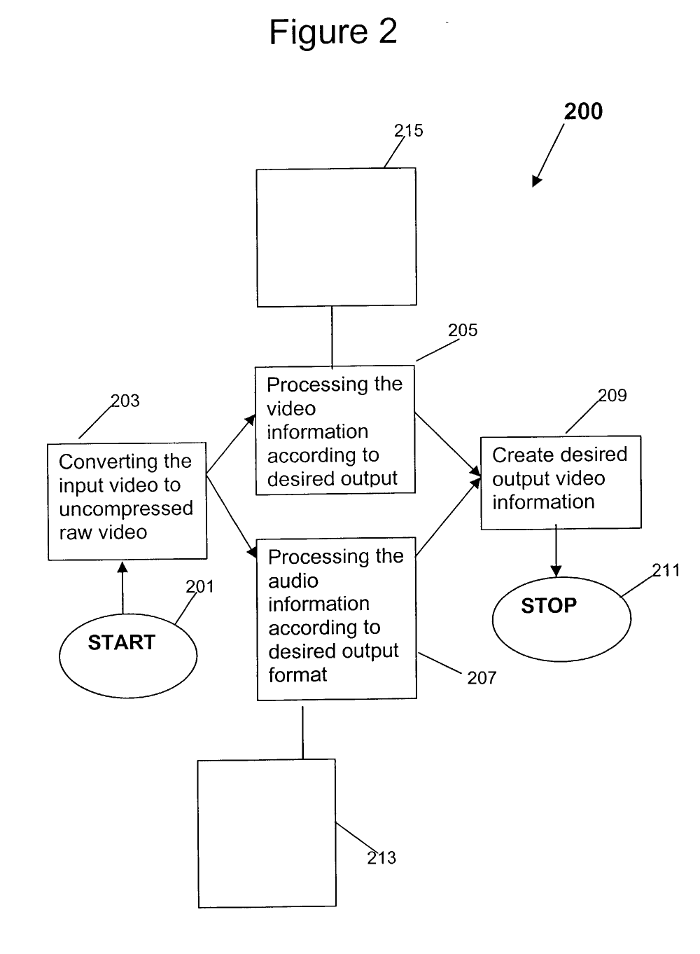

FIG. 2 is a simplified diagram of a video processing method 200 according to an embodiment of the present invention. This diagram is merely an example, which should not unduly limit the scope of the claims herein. One of ordinary skill in the art would recognize many other limitations, variations, and modifications. As shown, the method begins at start, step 201, where an incoming video information is converted to an outgoing presentation format, which is different from the incoming video information. The method first inputs video information (not shown) from a video source, e.g., analog, digital video, captured video streaming video. The video information can be in almost any format or any format. The method initiates a conversion process of the video information from an incoming format to a raw video format, e.g., uncompressed. The raw video format is often RGB, YUV, or others. Preferably, the conventional process includes a decoding process. The method also separates audio information, if available, from the video information.

The method transfers the raw video raw video without any intermediary files to a resizing and framing process or processes, step 205. Here, the method directly resizes the raw video information in the uncompressed format into a size associated with the desired output media format and the desired TV standard. The method also directly adjusts the uncompressed format in the size associated with the desired output media format and the desired TV standard to a frame rate associated with the desired TV standard. The method processes the uncompressed format in the size and the frame rate into an elementary video stream. The method also processes the audio information (step 207) into a desired output format. Preferably, the method uses one or more encoding processes. The encoding process can form a desired output such as DVD, VCD, and others.

Next, the method transfers the video and audio information in desired formats without any intermediary files in preferred embodiments. The method forms the desired audio/video output (step 209) using at least a multiplexing process, which combines audio and video information together. The method stops at step 211. Preferably, the method inputs (step 215) video format information based upon a plurality of different formats into the processing step 205 to form the desired output video. Such video format information is preferably provided by way of user interface but can also be others. Additionally, the method inputs (step 213) audio format information based upon a plurality of different formats into the processing step 207 to form the desired output audio. Such audio format information is preferably provided by way of user interface but can also be others. Of course, one of ordinary skill in the art would recognize many other ways of inputting the format information for audio and video.

Although the above has been described in terms of a specific sequence of steps in one or more processes, it would be recognized that there could be many alternatives, variations, and modifications. For example, any of the above elements can be further separated or combined with each other or other elements. Preferably, the functionality of the above elements is carried out using computer software. Alternatively, some of the elements can be implemented in software or implemented in computer code in a combination of hardware and software. Alternatively, the above elements can be further integrated in computer code in hardware or software or implemented in computer code in hardware and software or the like. Depending upon the embodiment, further details of these steps are provided below according to the figures.

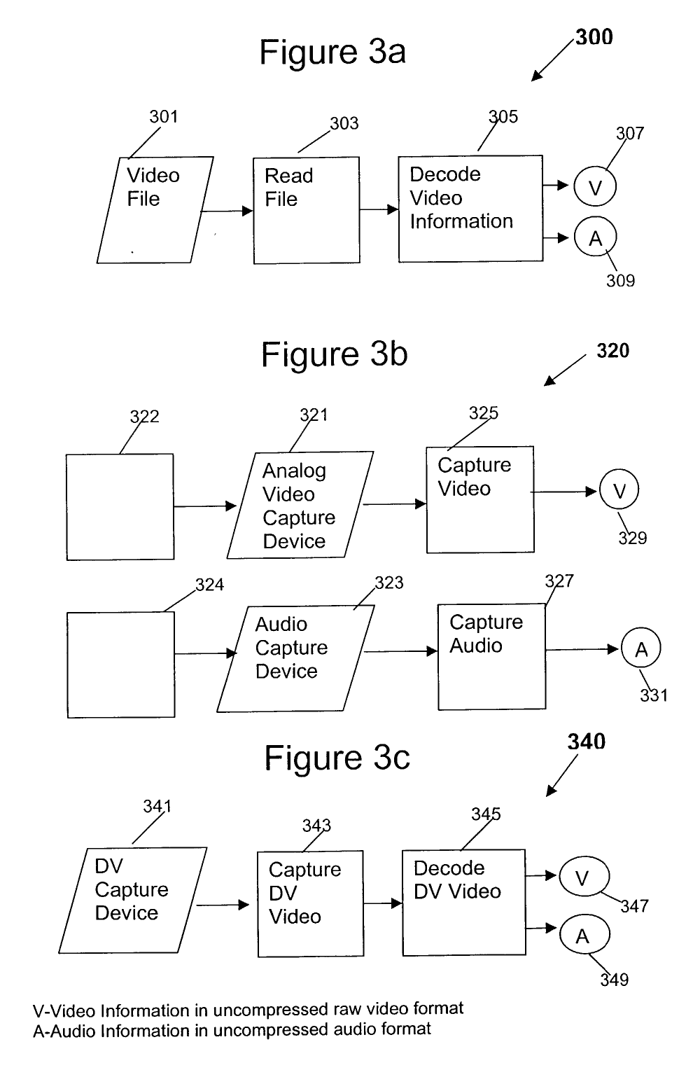

FIGS. 3A through 3C are more detailed diagrams of video input processes 300, 320, 340 according to embodiments of the present invention. These diagrams are merely examples, which should not unduly limit the scope of the claims herein. One of ordinary skill in the art would recognize many other limitations, variations, and modifications. As shown, any type or almost any type of video information can be input into the present method. Referring to FIG. 3A, the method inputs a video file 301. In a specific embodiment, the video file can be an AVI file, a QuickTime file, a Windows Media file, any combination of these, and others. The method reads the video file, step 303, to determine the type of file and format information. Depending upon the type of file and format information, the method decodes the video information, step 305. The decoded video information output (step 307) in an elementary or raw format such as RGB, YUV, and others. Audio information is also derived and separated from the video information, as shown by reference numeral 309.

In an alternative embodiment, the method includes providing captured video 321 and captured audio information 323. The captured video can be captured from any video capturing device. The video capturing device can include, among others, a video capture card connected to the bus of the computer, a USB video capture device. The video capturing device receives the video information from any analog video source, for example, a camcorder, a VCR, TV antenna, or others. The video capturing device digitizes the analog video information in a uncompressed raw video format. The audio capturing is provided using an audio capture device. The audio capture device can include, among others, a audio capture card connected to the bus of the computer, a USB audio capture device. The audio capturing device receives audio information from any audio source, for example, a camcorder, a VCR, TV antenna, microphone, or others. The audio capturing device digitizes the analog audio information in a uncompressed audio format. As merely an example, the captured video can be from a camera such as those manufactured by Sony, Panasonic, and others, as illustrated by reference numerals 322 and 324, respectively, for video and audio.

The method processes (step 325) the captured video information and also processes (step 327) the captured audio information. Preferably, the captured video information is processed by way of decoding to an elementary or raw video form 329 (e.g., uncompressed). The raw video form can include RGB, YUV, and others. The captured audio information is also processed by way of decoding to an elementary and/or uncompressed audio format, which includes PCM 331 (e.g., Pulse Code Modulation). The raw video and audio are outputted respectively to the next process steps without any intermediary files in preferred embodiments.

Alternatively, the method captures video information 341 using a digital video (“DV”) capturing device, such as a high speed serial bus commonly called IEEE 1394. The high speed bus can be used to capture both audio and video information. The captured video and audio information processed 343 using the capturing device. The processed information is then processed through a decoding process 345, which yields an uncompressed or elementary or raw video 347 information and audio 349 information. Of course, one of ordinary skill in the art would recognize many other alternatives, variations, and modifications.

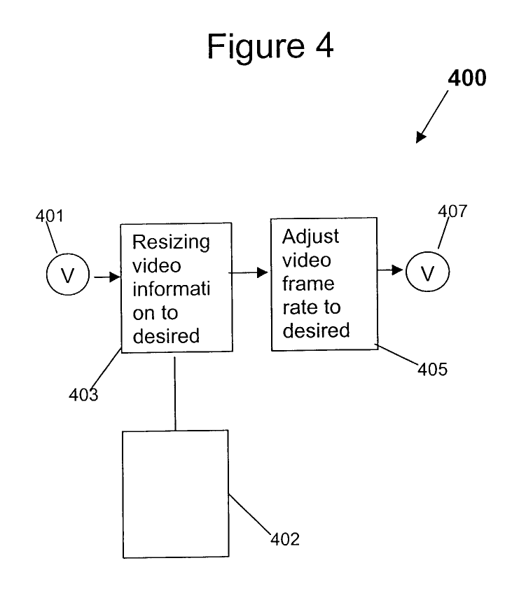

FIG. 4 is a more detailed diagram of a resizing and adjustment process 400 according to an embodiment of the present invention. This diagram is merely an example, which should not unduly limit the scope of the claims herein. One of ordinary skill in the art would recognize many other limitations, variations, and modifications. As shown, video information in an elementary or raw form is derived from a prior process, step 401. The method resizes the video information to a desired output format and a desired TV standard. As merely an example, the desired output format and TV standard are provided by user inputs. Such user inputs can be selected by way of a custom graphical user interface, which is coupled to the present method. As merely an example, selected sizes are provided according to Table 1.

TABLE 1

| Media | (National Television System | (Phase Alternate |
|---|---|---|
| Format♯TV Standard | Committee) NTSC Standard | Lines) PAL |
| DVD | 720 × 480 | 720 × 576 |
| | 352 × 480 | 352 × 576 |
| | 352 × 240 | 352 × 288 |
| VCD | 352 × 240 | 352 × 288 |
| Super VCD | 480 × 480 | 480 × 576 |

As can be seen, the media format can be DVD, VCD, or Super VCD, among others. Depending upon the embodiment, DVD can include sizes of those noted above, and may also include others for NTSC and PAL. In alternative embodiments, VCD can include sizes as noted above for NTSC and PAL. Still further, Super VCD can include sizes as noted above for NTSC and PAL. Preferably, the media format and TV standard are provided by way of user input (step 402). Of course, there may also be other variations, modifications, and alternatives, depending upon the embodiment. Additionally, other types of display sizes can also be used depending upon the embodiment.

The method also adjusts (step 405) a frame rate of the video information. Depending upon the embodiment, NTSC includes a frame rate of 29.97 Vertical Frame Frequency and PAL includes a Vertical Frame Frequency of 25. The frame rate is adjusted in a separate process from the sizing step, which has been described. Alternatively, the frame rate can be adjusted in other ways, depending upon the specific embodiment. Outgoing video information, which has been sized and framed, exits the process, as provided by reference numeral 407.

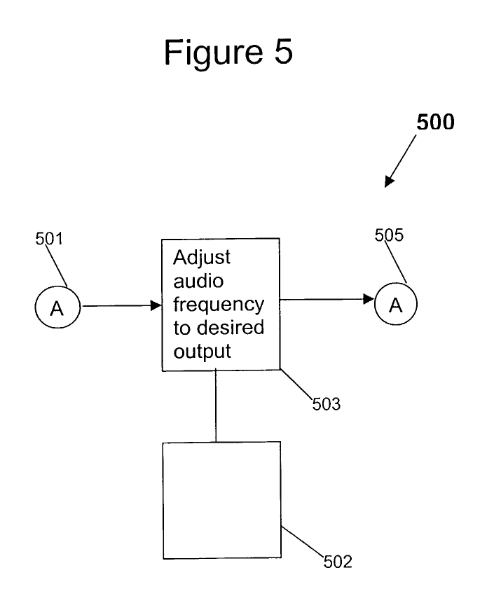

The method also processes 500 audio information as illustrated in the simplified diagram of FIG. 5. This diagram is merely an example, which should not unduly limit the scope of the claims herein. One of ordinary skill in the art would recognize many other limitations, variations, and modifications. As shown, the method inputs uncompressed audio information 501, which is derived from a prior process, such as the one noted above, but can be others. In a specific embodiment, the method includes a step of adjusting a frequency of the audio information according to a desired output format. As merely an example, the desired format can be found in Table 2.

TABLE 2

| Media Format/Information | Format | Frequency |
|---|---|---|
| DVD | Uncompressed | 48 kHz |
| | AC-3 | |
| | MEPG-1 | |
| | Layer 2 Audio | |
| VCD | MPEG 1 | 44.1 kHz |
| | Layer 2 Audio | |
| Super VCD | MPEG 1 Layer 2 Audio | 44.1 kHz |

As can be seen, the media format can be DVD, VCD, or Super VCD, among others. Depending upon the embodiment, the DVD format often uses a 48 kHz frequency rate. Alternatively, the VCD format often uses a 44.1 kHz frequency rate. As can be seen, the DVD and VCD uses MPEG 1 layer 2 Audio. Regardless of the final audio format, the audio is first converted to the desired frequency in this step. The adjusted audio is outputted to the next process, step 505. Preferably, the media format is provided by way of user input (step 502). Of course, there may also be other variations, modifications, and alternatives, depending upon the embodiment.

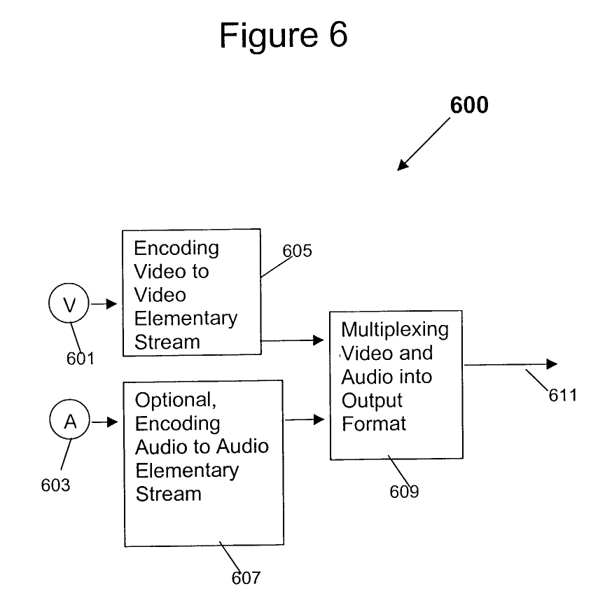

FIG. 6 is a more detailed diagram of a conversion process 600 according to an embodiment of the present invention. This diagram is merely an example, which should not unduly limit the scope of the claims herein. One of ordinary skill in the art would recognize many other limitations, variations, and modifications. Preferably, the method converts the raw video into a compressed elementary video, which is multiplexed with audio, to form an outgoing audio/video stream. The method receives uncompressed video 601 and encodes (step 605) such uncompressed video to from an elementary stream of video. Optionally, the method receives uncompressed audio and processes the audio using an encoding process (step 607) to form an elementary stream of audio information, which can be MPEG1 Layer 2 audio, AC-3 audio, among others. The elementary stream of audio information and the elementary stream of video information are multiplexed, step 609. The outgoing stream 611 is the multiplexed audio/video information. The outgoing stream can be in a variety of formats such as DVD, VCD, and Super VCD, among others.

Although the above has been described in terms of a specific sequence of steps in one or more processes, it would be recognized that there could be many alternatives, variations, and modifications. For example, any of the above elements can be further separated or combined with each other or other elements. Preferably, the functionality of the above elements is carried out using computer software. Alternatively, some of the elements can be implemented in software or implemented in computer code in a combination of hardware and software. Alternatively, the above elements can be further integrated in computer code in hardware or software or implemented in computer code in hardware and software or the like. Of course, the particular method will depend highly upon the application.

In an alternative embodiment, a method for adding video editing elements to the present invention can be outlined as follows:

1. Initiate conversion process;

2. Input video information;

3. Input video and audio media format information and TV standard;

4. Convert input video into uncompressed raw video;

5. Transfer uncompressed raw video without any intermediary files;

6. Process raw video to desired output format and TV standard based upon the inputted media format and TV standard;

7. Process audio information to desired output format based upon user input;

8. Transfer video and audio in desired formats with any intermediary files;

9. Perform editing process on the processed video in the desired output format and TV standard based upon selected user input;

10. Perform editing process on audio in desired output format based upon selected user input;

11. Form desired audio/video output; and

12. Perform other steps, as desired.

As shown, the method performs a sequence of steps to convert video information into a desired format without any intermediary files of conventional techniques. Preferably, the video information can be in almost any format or any format. The output video information can also be in any desired format, depending upon the embodiment. Preferably, editing features are also included. These and other features of the present method can be found throughout the specification and more particularly according to the figures below.

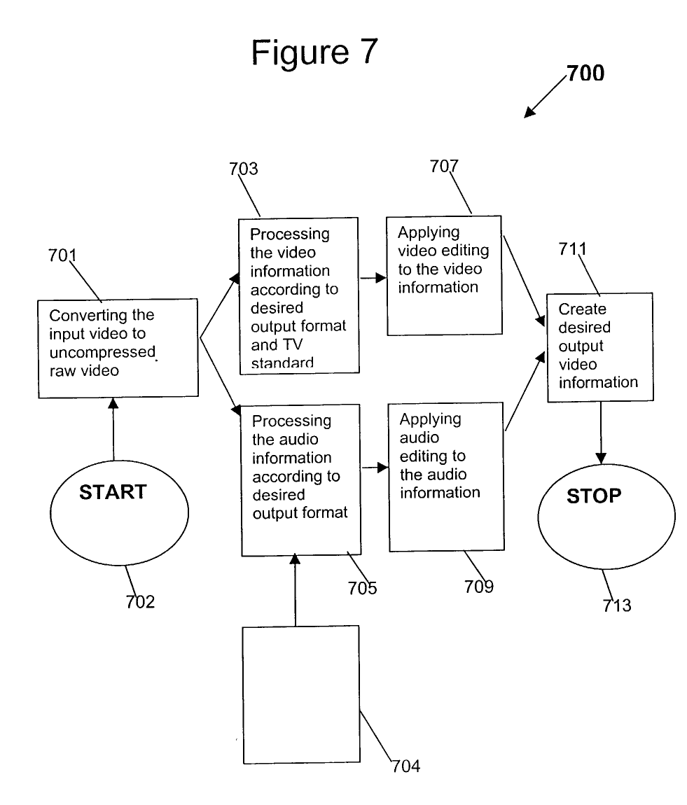

FIG. 7 is a simplified diagram of a digital video processing method 700 including an editing method according to an embodiment of the present invention. This diagram is merely an example, which should not unduly limit the scope of the claims herein. One of ordinary skill in the art would recognize many other limitations, variations, and modifications. As shown, the method begins at start, step 702. The method first inputs video information (not shown). The video information can be in almost any format or any format. The method initiates a conversion process (step 701) of the video information from an incoming format to a raw video format. The raw video format is often RGB, YUV, or others. Preferably, the conventional process includes a decoding process. The method also separates audio information, if available, from the video information.

The method transfers the raw video raw video without any intermediary files to a resizing and framing process or processes, step 703. Here, the method directly resizes the raw video information in the uncompressed format into a size associated with the desired output media format and the desired TV standard. The method also directly adjusts the uncompressed format in the size associated with the desired output media format and the desired TV standard to a frame rate associated with the desired TV standard. The method processes the uncompressed format in the size and the frame rate into an elementary video stream. The method also processes the audio information (step 705) into a desired output format. Preferably, the method uses one or more encoding processes. The encoding process can form a desired output such as DVD, VCD, and others.

Next, the method transfers the video and audio information in desired formats with any intermediary files in preferred embodiments. Preferably, the method includes a video editing process (step 707) to the video information. The editing process can be selected from fade, wipe, scroll, and others. Preferably, the method also includes a audio editing process (step 709) to the audio information. As merely an example, the audio editing process can include mixing with additional audio, fade, and others. The editing process is often input (step 704) by way of user input. The user input is provided through a graphical user interface. One of ordinary skill in the art would recognize many other limitations, variations, and modifications. The method forms the desired audio/video output (step 711) using at least a multiplexing process, which combines audio and video information together. The method stops at step 713. Although the above has been described in terms of a specific sequence of steps in one or more processes, it would be recognized that there could be many alternatives, variations, and modifications. For example, any of the above elements can be further separated or combined with each other or other elements. Preferably, the functionality of the above elements is carried out using computer software. Alternatively, some of the elements can be implemented in software or implemented in computer code in a combination of hardware and software. Alternatively, the above elements can be further integrated in computer code in hardware or software or implemented in computer code in hardware and software or the like. As merely an example, hardware used according to the present invention is provided in more detail below.

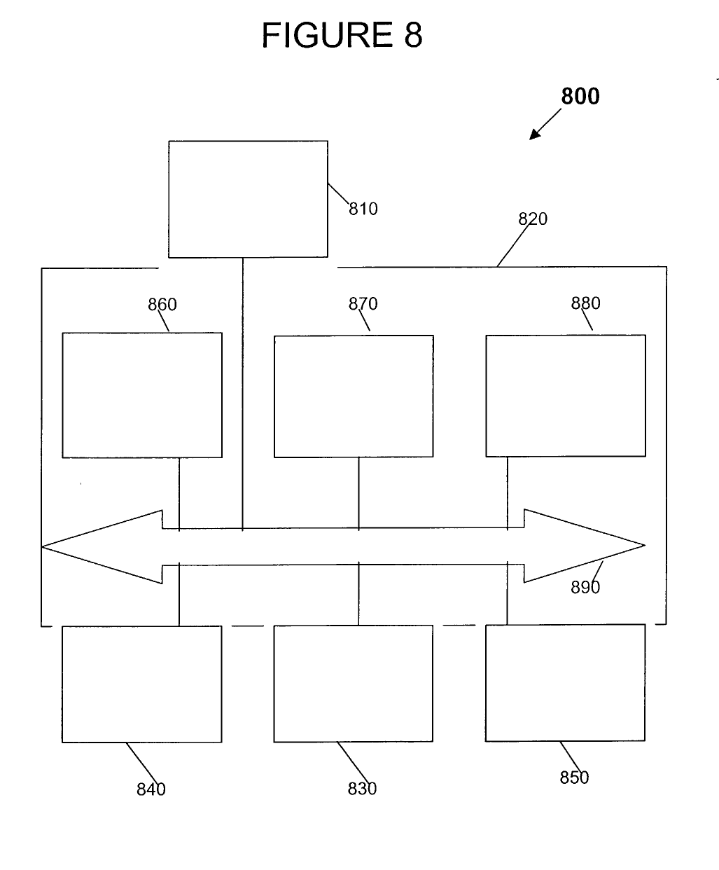

FIG. 8 is a simplified diagram of system hardware 800 according to an embodiment of the present invention. This diagram is merely an example, which should not unduly limit the scope of the claims herein. One of ordinary skill in the art would recognize many other limitations, variations, and modifications. The system 800 includes a monitor 810, a computing system 820, a user input device 830, a network interface 840, and a keyboard 850. Computing system 820 preferably includes familiar components such as a processor 860, and memory storage devices, such as a random access memory (RAM) 870, a fixed disk drive 880, and a system bus 890 interconnecting the above components. User input device 830 may include a mouse, a trackball, a keyboard, a keypad, a joystick, a digitizing tablet, a wireless controller, a microphone, or other input devices.

Random access memory 870 and fixed disk drive 880 are mere examples of tangible media for storage of computer programs, e-mail messages, audio and/or video data, e-mail client programs, and code implementing embodiments of the present invention. Other types of tangible media include SRAM, floppy disks, optical storage media such as CD-ROMs and bar codes, semiconductor memories such as flash memories, readonly-memories (ROMs), ASICs, battery-backed volatile memories, and the like.

Network interface 840 may be any type of interface to a computer network. For example network interface 840 may be a modem, an Ethernet or fast Ethernet interface, a LocalTalk connection, a satellite or other wireless connection, or the like. As disclosed above, the computer network may be any type of network such as the Internet, an Intranet, an IPX network, private tunnel, local area network (LAN), WAN, and the like.

In a preferred embodiment, computing system 820 includes a '586 class microprocessor running Windows2000™. operating system from Microsoft Corporation of Redmond, Wash. Many other computer systems, such as MacOS™ from Apple Corporation, running upon G3 based microprocessors, or Solaris™ from Sun Microsystems or UNIX running upon a SPARCstation, and the like can also be used. The system above discloses examples of configurations that embody the present invention. It will be readily apparent to one of ordinary skill in the art that many system types, configurations, and combinations of the above devices are suitable for use in light of the present disclosure. Of course, the types of system elements used depend highly upon the application.

Computer software codes to carry out the functionality herein are provided in one or more memories.

A method for direct disc writing according to an embodiment of the present invention is provided below.

1. List video programs to be placed on a disc;

2. Check on availability of random access media;

3. Process video information and begin writing to disc;

4. Complete writing of video information on disc;

5. Form navigation information and begin writing on disc;

6. Complete writing of navigation information on disc;

7. Write file system for video information on disc;

8. Close disc;

9. Complete other steps as desired, and

10. Output selected video program from disc.

The above steps provides a way to write video information directly to a disc. Preferably, video presentation information is prepared and written onto the disc at a selected address. Next, navigation information and then file system information are provided on the disc. Depending upon the embodiment, there can be other modifications, variations, and alternatives. Further details of these steps can be found throughout the present specification and more particularly below.

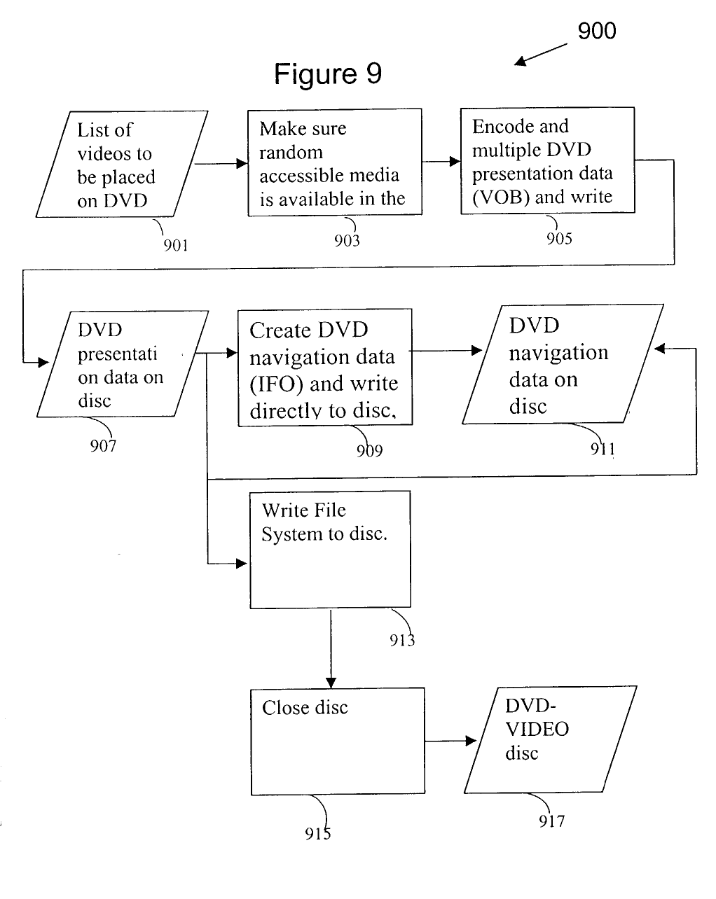

FIG. 9 is a simplified diagram 900 of an overall direct writing method according to an embodiment of the present invention. This diagram is merely an example, which should not unduly limit the scope of the claims herein. One of ordinary skill in the art would recognize many other limitations, variations, and modifications. As shown, the method begins by listing (step 901) one or more videos from a plurality of videos from a video source. The video source can include a multimedia file, analog video capture, and digital video capture. Alternatively, the videos can also be replaced or combined with audio or other forms of data and/or information, depending upon the application. Such videos will be placed on a disc, such as a CD, DVD, or other optical media.

The method determines (step 903) an availability of random access media. The random access media is preferably DVD media or the like. Alternatively, the random access media can be DVD+RW, or DVD−RAM. The method processes (step 905) the selected videos using a decoding and encoding process. Further details of such process have been previously described but will also be described in more detail in reference to the Figure below. Before describing such Figure, the overall method will be described as follows. The method begins writing selected video information onto disc. Preferably, the method writes directly starting at a desired position. The desired position is a fixed position based upon DVD-VIDEO Specifications published by DVD Forum, located in Tokyo, Japan. As merely an example, the fixed position is 1 MB.

The method continues to write the video information until all of the selected videos have been written onto disc. Preferably, the method continuously transfers the video information in a presentation format from the beginning through a common bus to an output for a disc writer free from an intermediary storage of the video and audio information from the beginning to the end (step 907). The method writes the video information in the presentation format from the beginning to a first portion of an optical media while other portions of the video and audio information are being processed to the presentation format. Of course, there can be other variations, modifications, and alternatives.

The method then processes navigation information (step 909). Preferably, the method determines an end point of writing the video information into the first portion of the optical media based upon a fixed address and a length of the video information and transfers a navigation system for the optical media to the optical media and writes (step 911) the navigation system (917) into a second portion of the optical media. Thereafter, the method writes a file system for the videos onto the disc. Preferably, the method initiates and writes the fixed address and the length of the video information into a third portion of the optical media, which corresponds to a portion of optical media for the file system. Now, the video information, navigation information, and file system have been written onto the disc. The disc is closed, step 915. The disc is now ready for playing one of the videos, step 917.

Although the above has been described in terms of a specific sequence of steps in one or more processes, it would be recognized that there could be many alternatives, variations, and modifications. For example, any of the above elements can be further separated or combined with each other or other elements. Preferably, the functionality of the above elements is carried out using computer software. Alternatively, some of the elements can be implemented in software or implemented in computer code in a combination of hardware and software. Alternatively, the above elements can be further integrated in computer code in hardware or software or implemented in computer code in hardware and software or the like.

A method for encoding according to an embodiment of the present invention is provided as follows.

1. List selected videos to be placed on disc from one or more sources of video information;

2. Determine if there are more videos?

3. If so, is it the first video?

4. If so, use pre-determined fixed address as a start address, which has been stored in random access memory;

5. Alternatively, if not, use the end address of last encoding as a start address;

6. Encode video;

7. Multiplex video with audio;

8. Write video;

9. Determine start address and length of video for the video encoded and written;

10. Store start address and length of video for the encoded and written video;

11. Return to step (2);

12. If not (no more videos), output list of start addresses and lengths for each of the video recordings;

13. Perform other steps, as desired.

The above steps provide a way to process of encoding video according to a specific embodiment of the present invention. As shown, the method processes and writes video information for a plurality of videos continuously onto a disc media. The method determines a start address and determines a length of video information to an end address. Depending upon a quantity of videos, the method recalculates the end address. Further details of this method are provided below according to the Figure below.

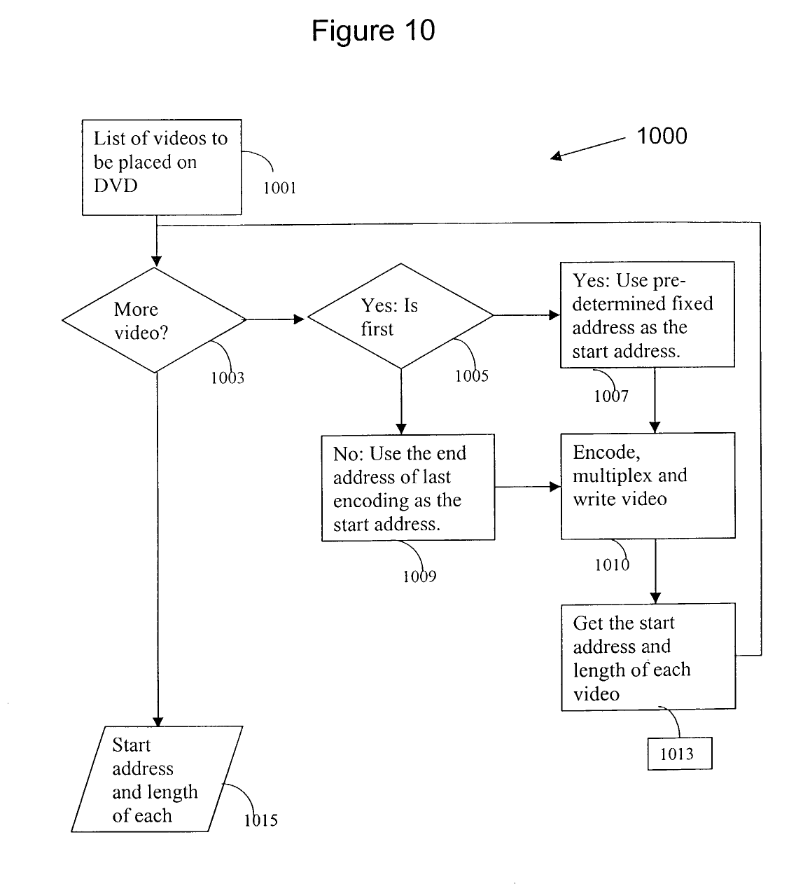

FIG. 10 is a simplified diagram of an encoding process 1000 according to an embodiment of the present invention. This diagram is merely an example, which should not unduly limit the scope of the claims herein. One of ordinary skill in the art would recognize many other limitations, variations, and modifications. As shown, the method begins by listing (step 1001) one or more videos from a plurality of videos from a video source. The video source can include multimedia file, analog video capture, and digital video capture. Alternatively, the videos can also be replaced or combined with audio or other forms of data and/or information, depending upon the application. Such videos will be placed on a disc, such as a CD, DVD, or other optical media.

The method includes a continuous process, which processes video recordings one by one according to a specific embodiment. The method determines if there are more videos (step 1003). If the video is a first video (step 1005), the method uses a predetermined fixed address (step 1007) as a start address, which has been stored in random access memory. If the video is not the first video, the method uses the end address of last encoding as a start address. The method then processes the video (step 1001), which includes encoding, multiplexing the video with audio, and writing the video to an optical disc media. Once the video has been written, the method determines (step 1013) the start address and length of video for the video encoded and written. The method then stores the start address and length of video for the encoded and written video in random access memory or the like. The method then returns to step 1003 via loop branch. If there not any more videos, the method outputs (step 1015) a list of start addresses and lengths for each of the video recordings. The method then performs other steps, as desired. The start addresses and length are used for other processes that are described in more detail throughout the present specification and more particularly below.

Although the above has been described in terms of a specific sequence of steps in one or more processes, it would be recognized that there could be many alternatives, variations, and modifications. For example, any of the above elements can be further separated or combined with each other or other elements. Preferably, the functionality of the above elements is carried out using computer software. Alternatively, some of the elements can be implemented in software or implemented in computer code in a combination of hardware and software. Alternatively, the above elements can be further integrated in computer code in hardware or software or implemented in computer code in hardware and software or the like.

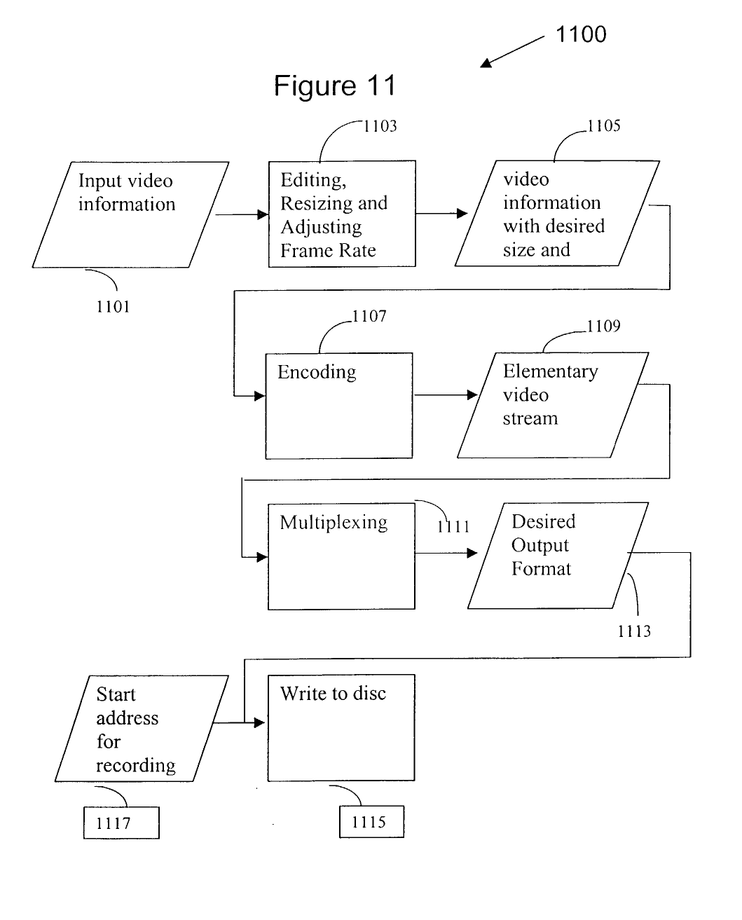

FIG. 11 is a more detailed diagram 1100 of an encoding process according to an embodiment of the present invention. This diagram is merely an example, which should not unduly limit the scope of the claims herein. One of ordinary skill in the art would recognize many other limitations, variations, and modifications. As shown, the method inputs video information 1101. The video information is edited, resized and adjusted for frame rate (step 1103). Preferably, the method outputs (step 1105) the video information with the desired size and frame rate based upon one or more inputs from a user. Next, the method performs an encoding process (step 1107). The encoding process outputs an elementary video stream (step 1109). The elementary video stream is combined with audio via a multiplexing process (step 1111). The method then outputs (step 1113) a desired audio/video information.

Preferably, the method converts video information from an incoming format to an outgoing format using a process free from one or more intermediary files. Such method writes the video information onto a disc based upon a selected start address. The method includes receiving video information in a first format and receiving a desired output media format based upon a first input and a desired TV standard based upon a second input. The method decodes the video information in the first format to raw video information in an uncompressed format and directly resizes the raw video information in the uncompressed format into a size associated with the desired output media format and the desired TV standard. The method adjusts the uncompressed format in the size associated with the desired output media format and the desired TV standard to a frame rate associated with the desired TV standard and encodes the uncompressed format in the size and the frame rate into an elementary video stream. A step of multiplexing the elementary video stream with audio information in the desired output media format and the desired TV standard to form video and audio information in a presentation format based upon the desired output media format and the desired TV standard is included. The method receives a start address 1117 for recording, which was provided by a prior method or can be from alternative methods. Once the start address has been provided, the method begins initiating writing (step 1115) the video/audio information onto the disc. Additionally, the method determines a start address and a length for the video recording that has been encoded and written. Such start address and length is stored in memory and will be used for other processes according to certain embodiments. Some of these embodiments have been described in this specification and more particularly below.

Although the above has been described in terms of a specific sequence of steps in one or more processes, it would be recognized that there could be many alternatives, variations, and modifications. For example, any of the above elements can be further separated or combined with each other or other elements. Preferably, the functionality of the above elements is carried out using computer software. Alternatively, some of the elements can be implemented in software or implemented in computer code in a combination of hardware and software. Alternatively, the above elements can be further integrated in computer code in hardware or software or implemented in computer code in hardware and software or the like.

A method for writing video navigation information is provided as follows:

1. Determine end point of writing video information onto the disc;

2. Identify start address and length of each video recording, e.g., four files would be four video recordings, each having a start address and length, which can be from one of the prior methods;

3. Form video navigation structure in random access memory based upon the start address and length of each of the video recordings according to the industry standard DVD-VIDEO specification published from the DVD Forum of Tokyo, Japan;

4. Transfer video navigation structure from the random access memory to a predetermined fixed address location (which has been reserved) on the optical disc;

5. Determine length information of the navigation structure;

6. Transfer length information to next process; and

7. Perform other steps, as desired.

The above sequence of steps provides a way to form a navigation structure and write it on an optical disc according to an embodiment of the present invention. Such steps can be combined with certain others, as described herein, to form a continuous process to write video recordings, navigation information, and a file system according to a preferred embodiment of the present invention. Further details of these steps can be found more particularly below.

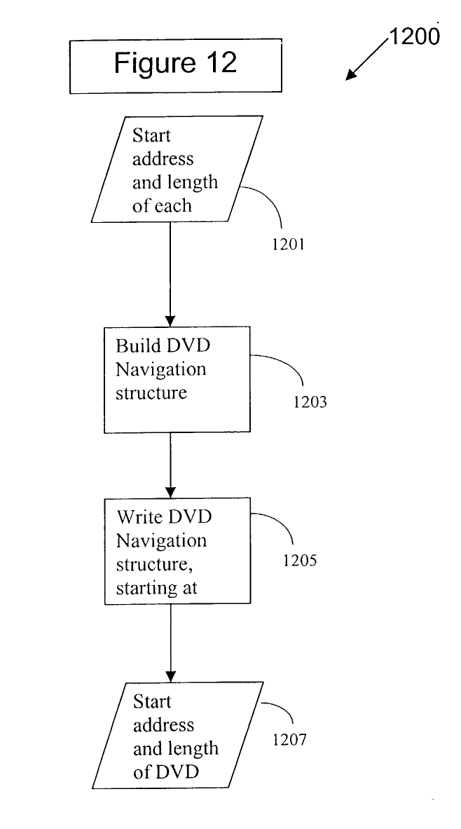

FIG. 12 is a simplified diagram of a process 1200 of writing video navigation information according to an embodiment of the present invention. This diagram is merely an example, which should not unduly limit the scope of the claims herein. One of ordinary skill in the art would recognize many other limitations, variations, and modifications. As shown, the method determines an end point of writing video information onto the disc. Preferably, the video information includes video recordings, e.g., four files would be four video recordings. The method identifies (step 1201) a start address and length of each video recording. Each of the video recordings has a start address and length, which can be from one of the prior methods, or other techniques.

Next, the method forms (step 1203) a video navigation structure using the start address and length information. Preferably, the video navigation structure, which is stored in random access memory, is based upon the start address and length of each of the video recordings according to the industry standard DVD-VIDEO specification published from the DVD Forum of Tokyo, Japan, but can also be from other standards or formats depending upon the application. Of course, one of ordinary skill in the art would recognize many other variations, modifications, and alternatives.

The method transfers the video navigation structure from the random access memory to a predetermined fixed address location (which has been reserved) on the optical disc. Preferably, the video navigation structure is transferred from the random access memory from a computer through a bus to an optical reading and/or writing device, such as a DVD writer. The transfer is continuous through these various computing devices in certain embodiments. The method writes the navigation structure from the predetermined fixed address location, as noted. Preferably, once the navigation structure has been transferred and written onto the optical disc, the method determines length information of the navigation structure. The method transfers (step 1207) the length information and the start address to a next process, depending upon the application. Depending upon the embodiment, other steps can also be performed.

Although the above has been described in terms of a specific sequence of steps in one or more processes, it would be recognized that there could be many alternatives, variations, and modifications. For example, any of the above elements can be further separated or combined with each other or other elements. Preferably, the functionality of the above elements is carried out using computer software. Alternatively, some of the elements can be implemented in software or implemented in computer code in a combination of hardware and software. Alternatively, the above elements can be further integrated in computer code in hardware or software or implemented in computer code in hardware and software or the like. Additionally, the process goes on to the next step, which writes video file system information onto the optical disc. Further details of this process can be found below.

According to an alternative specific embodiment, the invention provides a process for writing video file system information as follows:

1. Receive start address and length of each of the video recordings;

2. Receive start address and length of the navigation structure;

3. Determine start address and length of each VOB (Video Object) file according to the DVD-VIDEO specifications based upon the information from at least step 1;

4. Determine start address and length of IFO (DVD Navigation Information) files based upon the information of at least step 2;

5. Form file system structure based upon at least steps 3 and 4;

6. Store file system in random access memory;

7. Transfer file system from the random access memory to an optical disc;

8. Write file system onto the optical disc onto a predetermined address, which is based upon the UDF (Universal Disk Format)specification;

9. Perform closing process on the disc; and

10. Perform other steps, as desired.

The above sequence of steps provides a way to form a file system and write it on an optical disc according to an embodiment of the present invention. Such steps can be combined with certain others, as described herein, to form a continuous process to write video recordings, navigation information, and a file system according to a preferred embodiment of the present invention. Further details of these steps can be found more particularly below.

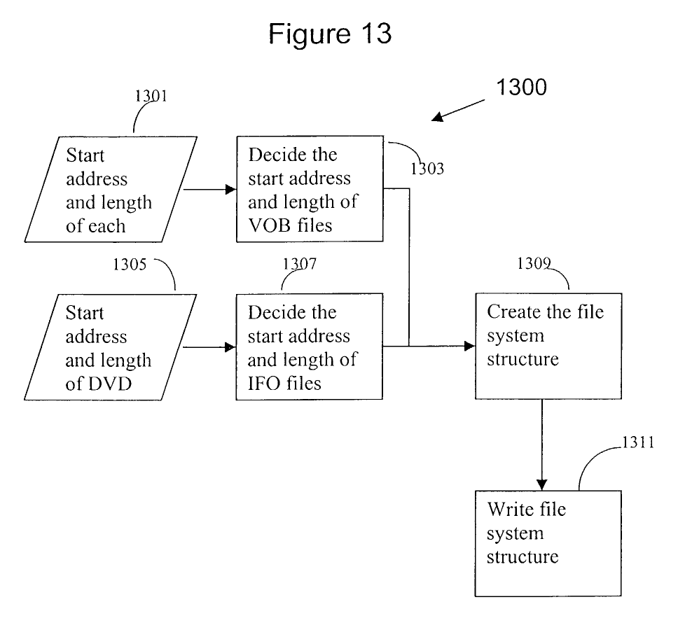

FIG. 13 is a simplified diagram 1300 of a process of writing video file information according to an embodiment of the present invention. This diagram is merely an example, which should not unduly limit the scope of the claims herein. One of ordinary skill in the art would recognize many other limitations, variations, and modifications. As shown, the method includes receiving (step 1301) start address and length of each of the video recordings. The method also receives (step 1305) start address and length of the navigation structure. The method determines (step 1303) start address and length of each VOB (Video Object) file according to the DVD-VIDEO specifications based upon the start address and length of each of the video recordings. The start address and length for each VOB file may often not correspond to the start address and length of each of the video recordings.

The method determines (step 1307) start address and length of IFO (DVD Navigation Information) files based upon the start address and length for the navigation structure. The start address and length of IFO files would correspond to the start address and length of the IFO files.

The method forms (step 1309) a file system structure based upon the prior processes. Preferably, the file system is formed using information from the start address and length of the VOB files and start address and length of IFO files. The file system is stored in memory, such as random access memory. The method transfers the file system from the random access memory to optical disc. Preferably, the file system is transferred from the memory of a personal computer through a bus to an ouput port to the optical disc writer. The method writes (step 1311) file system onto the optical disc onto a predetermined address, which is based upon the UDF (Universal Disk Format)specification. The method performs a closing process such as writing lead-out area on the disc. Of course, others steps can also be performed.

Although the above has been described in terms of a specific sequence of steps in one or more processes, it would be recognized that there could be many alternatives, variations, and modifications. For example, any of the above elements can be further separated or combined with each other or other elements. Preferably, the functionality of the above elements is carried out using computer software. Alternatively, some of the elements can be implemented in software or implemented in computer code in a combination of hardware and software. Alternatively, the above elements can be further integrated in computer code in hardware or software or implemented in computer code in hardware and software or the like.

Computer software codes to carry out the functionality herein are provided in one or more memories.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for directly writing video information to optical disc media, the method comprising:
converting a video information in a first format to a raw video information in an uncompressed format;
resizing the raw video information in the uncompressed format into a size associated with a desired output media format and a desired TV standard and adjusting the uncompressed format in the size associated with the desired output media format and the desired TV standard to a frame rate associated with the desired TV standard;
processing the uncompressed format in the size and the frame rate into an elementary video stream and processing the elementary video stream with audio information in the desired output media format and the desired TV standard to form video and audio information in a presentation format including a beginning and an end based upon the desired, output media format and the desired TV standard;
continuously transferring the video and audio information in the presentation format from the beginning through a common bus to an output for a disc writer free from an intermediary storage of the video and audio information from the beginning to the end; and,
writing the video and audio information in the presentation format from the beginning to a first portion of an optical media while other portions of the video and audio information are being processed to the presentation format.

2. The method of claim 1 wherein the optical media is a random accessible media.

3. The method of claim 1 further comprising determining a fixed address for the video and audio information in the presentation format and determining a length of the video and audio information in the presentation format and storing the fixed address in a first portion of a temporary memory and storing the length of the video and audio information in a second portion of the temporary memory.

4. The method of claim 3 further comprising writing the fixed address and the length of the video and audio information into a third portion of the optical media, the fixed address and the length being a portion of a file system.

5. The method of claim 1 further comprising determining an end point of writing the video and audio information into the first portion of the optical media based upon a fixed address and a length of the video and audio information and transferring a navigation system for the optical media to the optical media and writing the navigation system into a second portion of the optical media.

6. The method of claim 1 wherein the optical disk media is a DVD format.

7. The method of claim 1 wherein the hard disk media is a hard disk drive

8. The method of claim 1 further comprising capturing the video information in the first format.

9. The method of claim 8 wherein the capturing is initiated at time T1 and the writing is initiated at time T2, whereupon T1 and T2 are substantially a same time.

10. The method of claim 9 wherein T1 is no less than 5 seconds from T2 .

11. The method of claim 1 further comprising:
determining a fixed address for the video and audio information in the presentation format;
determining a length of the video and audio information in the presentation format;
storing the fixed address in a first portion of a temporary memory;
storing the length of the video and audio information in a second portion of the temporary memory;
determining an end point of writing the video and audio information into the first portion of the optical media based upon the fixed address and the length of the video and audio information;
transferring a navigation system for the optical media to the optical media and writing the navigation system into a second portion of the optical media; and
writing the fixed address and the length of the video and audio information into a third portion of the optical media, the fixed address and the length being a portion of a file system. An example of the file system is UDF(Universal Disk Format)/ISO9660 Bridge.

12. The method of claim 1 further comprising capturing the video information whereupon the writing is completed within a predetermined time of the capturing, the predetermined amount of time being less than about 5 seconds.

13. The method of claim 1 wherein the writing is a physical burn-in process of the video and audio information.

14. The method of claim 1 wherein the method is under a control of a single microprocessing device.

15. The method of claim 1 wherein the converting, resizing, adjusting, processing, continuously transferring, and writing are provided using one or more computer codes.

16. A computer system for directly writing video information to optical disc media, the system including one or more memories, the one or more memories comprising:
one or more codes directed to converting a video information in a first format to a raw video information in an uncompressed format;
one or more codes directed to resizing the raw video information in the uncompressed format into a size associated with a desired output media format and a desired TV standard and adjusting the uncompressed format in the size associated with the desired output media format and the desired TV standard to a frame rate associated with the desired TV standard;
one or more codes directed to processing the uncompressed format in the size and the frame rate into an elementary video stream and processing the elementary video stream with audio information in the desired output media format and the desired TV standard to form video and audio information in-a presentation format including a beginning and an end based upon the desired output media format and the desired TV standard;
one or more codes directed to initiate continuously transferring the video and audio information in the presentation format from the beginning through a common bus to an output for a disc writer free from an intermediary storage of the video and audio information from the beginning to the end; and
one or more codes directed to initiate writing the video and audio information in the presentation format from the beginning to a first portion of an optical media while other portions of the video and audio information are being processed to the presentation format.

17. The system of claim 16 wherein the optical media is a random accessible media.

18. The system of claim 17 further comprising:
one or more codes directed to determining a fixed address for the video and audio information in the presentation format;
one or more codes directed to determining a length of the video and audio information in the presentation format;
one or more codes directed to storing the fixed address in a first portion of a temporary memory;
one or more codes directed to storing the length of the video and audio information in a second portion of the temporary memory;
one or more codes directed to determining an end point of writing the video and audio information into the first portion of the optical media based upon the fixed address and the length of the video and audio information;
one or more codes directed to initiate transferring a navigation system for the optical media to the optical media and writing the navigation system into a second portion of the optical media; and
one or more codes directed to initiate writing the fixed address and the length of the video and audio information into a third portion of the optical media, the fixed address and the length being a portion of a file system.

19. A computer system for directly writing video information to optical disc media from a video source, the system including one or more memories, the one or more memories comprising:
one or more codes directed to converting a video information in a first format to a raw video information in an uncompressed format;
one or more codes directed to resizing the raw video information in the uncompressed format into a size associated with a desired output media format and a desired TV standard and adjusting the uncompressed format in the size associated with the desired output media format and the desired TV standard to a frame rate associated with the desired TV standard;
one or more codes directed to processing the uncompressed format in the size and the frame rate into an elementary video stream and processing the elementary video stream with audio information in the desired output media format and the desired TV standard to form video and audio information in a presentation format including a beginning and an end based upon the desired output media format and the desired TV standard;
one or more codes directed to initiate continuously transferring the video and audio information in the presentation format from the beginning through a common bus to an output for a disc writer free from an intermediary storage of the video and audio information in entirety from the beginning to the end;
one or more codes directed to initiate writing the video and audio information in the presentation format from the beginning to a first portion of an optical media while other portions of the video and audio information are being processed to the presentation format;
one or more codes directed to determining a fixed address for the video and audio information in the presentation format;
one or more codes directed to determining a length of the video and audio information in the presentation format;
one or more codes directed to storing the fixed address in a first portion of a temporary memory;
one or more codes directed to storing the length of the video and audio information in a second portion of the temporary memory;
one or more codes directed to determining an end point of writing the video and audio information into the first portion of the optical media based upon the fixed address and the length of the video and audio information;
one or more codes directed to forming a navigation system based upon the fixed address and the length of the video and audio information;
one or more codes directed to storing the navigation system into a third portion of temporary memory;
one or more codes directed to initiate transferring the navigation system from the third portion of the temporary memory to the optical media and writing the navigation system into a second portion of the optical media;
one or more codes directed to forming a file system based upon at least the fixed address and the length;
one or more codes directed to storing the file system onto a fourth portion of temporary memory; and
one or more codes directed to transfer the file system from the temporary memory to initiate writing the file system onto a third portion of the optical media.

20. The system of claim 19 wherein the one or more codes directed to initiate continuously transferring the video and audio information in the presentation format from the beginning through a common bus to an output for a disc writer free from an intermediary storage of the video and audio information in entirety from the beginning to the end, the one or more codes directed to initiate transferring the navigation system from the third portion of the temporary memory to the optical media and writing the navigation system into a second portion of the optical media, and the one or more codes directed to transfer the file system from the temporary memory to initiate writing the file system onto a third portion of the optical media are performed sequentially without storing the video and audio information, the navigation system, and the file system on a disk medium in entirety onto a memory that is not the optical media before executing any of the codes.
